(19) United States
(12) Patent Application Publication
(10) Pub. No.: US 2005/0057595 A1
(43) Pub. Date: Mar. 17, 2005

(54) Method and printer for applying an ink image to a receiving material

(76) Inventor: Eduard T.H. De Grijs, Venlo (NL)

Correspondence Address: BIRCH STEWART KOLASCH & BIRCH, PO BOX 747, FALLS CHURCH, VA, 22040-0747, US

(21) Appl. No.: 10/940,644

(22) Filed: Sep. 15, 2004

(30) Foreign Application Priority Data
Sep. 16, 2003 (EP) 03077931.8

(51) Int. Cl. B41J 29/393

(52) U.S. Cl. 347/16; 347/19

(57) ABSTRACT

A method for applying an ink image to a receiving material using a printer containing a carriage holding a print head, the carriage being moveable along a carriage scan-axis for applying the ink image to a strip of receiving material, transporting means for stepwise advancing the receiving material in a direction of advance, which extends to a direction substantially orthogonal to the carriage scan-axis, and a camera mounted on the carriage adjacent to the print head for detecting a reference pattern, wherein the camera is arranged for imaging an area which extends in the direction of advance, said method including the steps of: moving the carriage for printing a swath in a direction wherein the camera is positioned upstream to the print head, detecting the position of a reference pattern on the receiving material relative to the carriage, determining deviations in said position from a desired position, and adjusting the position of the receiving material in the direction of advance for at least partially correcting for the deviations during the movement of the carriage.

This non-provisional application claims priority under 35 U.S.C. 119(a) on Patent Application No. 03077931.8 filed in Europe on Sep. 16, 2003, which is herein incorporated by reference.

### BACKGROUND OF THE INVENTION

The present invention relates to a method for applying an ink image to a receiving material. In particular the present invention relates to a printing method used in a swath-type printer. The present invention further relates to a printer for applying an ink image to a receiving material.

Swath-type printers are well known in the art. Typically such printers include a carriage for holding a print head, which carriage is moveable along a carriage scan-axis for applying an ink image to a strip of receiving material. The receiving material, such as a paper sheet, is stepwise advanced in the direction of advance, which extends in a direction substantially orthogonal to the carriage scan-axis. During the printing of an image, the carriage is driven back and forth along the scan-axis to print successive swaths with the print head. A transporting element is provided for the stepwise advancing of the receiving material between each successive swath. A known problem with swath-type printers is the accurate positioning of the stepwise advancing of the receiving material effected by the transporting element. The need for precise positioning of the receiving material is increased when the printer is a high-resolution printer used for printing graphics with high resolution.

U.S. Pat. No. 4,916,638 describes a media advance-system for swath-type printers for precise positioning of the receiving material for successive swath-printing. This media advance-system is provided with a dual photodiode sensor, which is mounted on the print head. This print head is provided with N nozzles which are positioned along a line that extends in the direction of advance of the receiving material. The print head is used to print lines in the margin of the receiving material using the first and Nth nozzle of the print head. These lines in the margin can be detected with the dual photodiode sensor. In order to obtain a defined stepwise advancing of the receiving material, the following method is used: First, the sensor is positioned over a line in the margin printed by the first nozzle, and the resulting difference signal of the two photodiodes of the sensor is saved as a reference value. Subsequently, the receiving material is advanced until the same value of the difference signal is obtained from the line image of the marginal line drawn by the Nth nozzle. Finally, the receiving material is advanced over a predetermined amount to position the receiving material for the next successive swath to be printed.

A disadvantage of the known method is that after each advancing step of the receiving material, a calibration step is required for positioning the receiving material before the next successive swath can be printed.

A further disadvantage is that the advancement of the receiving material is relatively slow in order to obtain the same value of the difference signal and not to overshoot this position.

Another disadvantage is, that after the accurate advancement of the receiving material until the same value of the difference signal is obtained, the receiving material is subsequently advanced at a predetermined amount to position the receiving material for the next successive swath to be printed. This subsequent advancement over said predetermined amount may introduce positioning errors.

### SUMMARY OF THE INVENTION

The present invention pertains to a method for applying an ink image to a receiving material using a printer including:
a carriage for holding a print head, said carriage being moveable along a carriage scan-axis for applying an ink image to a strip of receiving material,
transporting means for the stepwise advancing of the receiving material in a direction of advance, which extends in a direction substantially orthogonal to the carriage scan-axis, and
a camera mounted on the carriage adjacent to the print head for detecting a reference pattern, wherein the camera is arranged for imaging an area which extends in the direction of advance.

The method includes the steps of:
moving the carriage for printing a swath in a direction wherein the camera is positioned upstream to the print head,
detecting the position of a reference pattern on the receiving material relative to the carriage, determining deviations in said position from a desired position, and
adjusting the position of the receiving material in the direction of advance, for at least partially correcting for said deviations, during the movement of the carriage.

Due to the use of a camera which extends in the direction of advance of the receiving material, the camera can image a much larger field than the sensor as described in U.S. Pat. No. 4,916,638. A further advantage of the use of a camera which can image a larger area in the direction of the advancing of the receiving material than the known sensor, is that the reference pattern does not have to be always on the same place in a swath.

During the movement of the carriage wherein the camera is mounted upstream with respect to the print head, the camera moves in front of the print head. In this situation the camera can detect the position of a reference pattern relative to the carriage, and therefore relative to the print head, before the print head prints the first dots in the swath.

If the detected position of the reference pattern deviates from a desired position, the deviations between the detected position and the desired position are determined and the position of the receiving material is adjusted in the direction of advance for at least partially correcting for said deviations.

Subsequently, the print head prints the first dots in the swath. Thus, detecting and adjusting the position of the receiving material in the direction of advance relative to the print head can be preformed during the movement of the carriage for applying the ink image to the strip of receiving material. Consequently, the printing process of the present invention can be quicker than the method which defines the state of the art.

Moreover, since the camera images a much larger field than the sensor as described in U.S. Pat. No. 4,916,638 the problem of overshoot is less important, as long as the reference pattern is in the field of vision of the camera. Therefore the advancing of the receiving material can be done more quickly than with the state of the art methods.

In the case of a swath-type printer wherein the carriage is driven back and forth along the scan-axis to print the successive swaths, the method of the invention is applicable during every swath wherein the camera moves in an upstream position with respect to the print head. This means that a correction is possible at every second paper step. The result is that the average of more than one paper step will be more accurate.

In one embodiment, the method further includes the step of printing the reference pattern using the print head. In this case no special paper, for example one using a preprinted reference pattern, is required.

In another embodiment, the reference pattern is printed during the movement of the carriage wherein the camera is mounted downstream with respect to the print head. At the end of this swath wherein the reference pattern is printed, the receiving material is moved one swath forward (one stepwise advance). Subsequently the carriage will move backwards along the carriage scan-axis for printing the subsequent swath. In this subsequent swath the camera is mounted upstream with respect to the print head, and the method of the invention as described above can be used.

Moreover, the reference pattern can be printed and detected in one swath. Thus, because the camera is mounted downstream, it subsequently moves over the area onto which the reference pattern had just been printed by the print head.

In one embodiment, the camera images an area which extends in the direction of advance over a distance which is larger than a step of the stepwise advancing of the receiving material. The camera can now detect a first reference pattern in the same swath wherein said first reference pattern is printed by the print head as well as in the subsequent swath (after one stepwise advance). By comparing the position of said first reference pattern as determined in the swath wherein said first reference pattern is printed with the position of said first reference pattern after one stepwise advance, the distance of the stepwise advance of the receiving material can be determined. If the distance of said stepwise advance of the receiving material does not correspond to a desired amount of advance, then the position of the receiving material can be adjusted using correction means before the print head starts printing the subsequent swath, as described above.

In another embodiment of the method of the present invention, the reference pattern is printed within a safety margin along the edge of the receiving material. An advantage of this embodiment is, that the reference pattern does not disturb the printed ink image.

Moreover, the area where the ink image must be printed, i.e., the print-area, is often at a distance from the edge of the receiving material. In this case, the distance between the print-area and the reference pattern positioned along the edge of the receiving material provides a relatively large time-period between the detection of the reference pattern and the arriving of the moving print head at the print-area. Consequently this relatively large time-period is available for the determination of deviations in the position of the receiving material from a desired position, and for the adjustment of the position of the receiving material in the direction of advance for at least partially correcting for said deviations. Due to this relatively large time-period, less expensive electronics can be used for performing the method of the invention.

In a further embodiment of the present invention, the printer comprises processing means, and the method comprises the step of processing ink image data by using said processing means for introducing the reference pattern in the ink image. An advantage of this embodiment is that the reference pattern can be dispersed over the width of the receiving material. Consequently, more measurements can be done during the movement of the carriage over the receiving material, yielding a higher accuracy in the determination of variations in the stepwise advancing of the receiving material.

In one embodiment, the printed reference pattern is invisible for the naked eye. For example, the reference pattern is made so small that it cannot be seen with the naked eye, but can be detected by the camera. Preferably, the reference pattern is printed using yellow ink. On a white receiving material the yellow reference pattern has a low contrast, which further reduces the visibility of the reference pattern with the naked eye.

In one embodiment, the reference pattern comprises a line or dot pattern which extends substantially perpendicular to the direction of advance.

In another embodiment of the present invention, the ink image is printed in two or more passes of the carriage over the strip of receiving material, wherein the receiving material is stepwise advanced in the direction of advance, after each pass. Printers wherein an ink image to a strip of receiving material is printed in a number of passes are referred to as multipass printers. In such a multipass printer the total amount of needed ink on a certain position in the ink image is printed in n passes (n>2). As a consequence of this, the amount of ink increases in n steps in the direction of advance of the receiving material. Such a stepwise increase of the amount of ink, referred to as multipass edge, extends substantially perpendicular to the direction of advance and can be used to measure the stepwise advance of the receiving material of the previous (n−1) steps. An advantage of this embodiment is, that no reference pattern is required in the margin of the receiving material. Moreover, the reference pattern is dispersed over the width of the receiving material and is automatically generated by the multipass printing process. Thus, the introduction of the reference pattern in the ink image is not necessary.

In one embodiment, the print head comprises a first printing device for printing a first color of the ink image and a second printing device for printing a second color of the ink image, wherein the second color is different from the first color, which first and second printing devices are mounted adjacent to each other, wherein the first printing device is displaced in the direction of advance with respect to the second printing device. The method of the present invention further comprises the steps of moving the carriage over the strip of receiving material for a first pass, wherein only the first printing device prints on at least a part of the strip of receiving material, advancing the receiving material in the direction of advance over at least one step, and moving the carriage over the strip of receiving material for a second pass, wherein the second printing device prints on said part of the strip of receiving material. As a consequence of this, not only the amount of ink increases in steps in the direction of advance of the receiving material, but also the color changes in steps (here in at least two steps) in the direction of advance. This color change yields a multipass edge with an increased contrast, wherein the position of this multipass edge is easier and more accurate detectable.

In another embodiment, the printer comprises processing means, wherein the method comprises the step of processing ink image data by said processing means for introducing the reference pattern in a first part of the ink image and printing the reference pattern during the first pass, and for introducing a compensation pattern in a second part of the ink image and printing the compensation pattern during the second or a subsequent pass, wherein said compensation pattern neutralizes said reference pattern. An advantage of this method is that not only the multipass edges are available, but also an additional reference pattern is visible and can be used for further improving the accuracy with which the stepwise advancing of the receiving material can be determined.

In the case of a multipass printer which requires n passes over a strip of receiving material to complete the printing of the ink image on said strip of receiving material, reference patterns can be introduced to the first (n−1) passes. At the last pass (n) a correction is made to neutralize the introduced reference patterns, so that the use of the reference patterns will not be visible in the final print. The reference patterns will however be visible for the camera in the (n−1) previous passes. In this way, not only the multipass edges can be used to measure the stepwise advancing of the receiving material, but also all the positions of the reference patterns, making the measurement more accurate because more measurements can be made.

In one embodiment, the reference pattern is printed using yellow ink. In this case the printing device for the yellow ink image is the first to print on a strip of receiving material (other colors will be added in subsequent passes). The position of the yellow reference pattern with respect to the ink image to be printed is preferably such that these positions will be covered later by other inks, preferably by black ink, making the reference pattern invisible in the final print.

In another embodiment, the reference pattern includes a high frequency component parallel to the carriage scan-axis. The high frequency component is visible in the direction of advance of the receiving material. Such a high frequency component provides a uncomplicated reference pattern which can cover nearly the complete printing area (except of course, the part of the printing area which is printed during the last pass).

From another aspect the present invention pertains to a printer for applying an ink image to a receiving material, including:
a carriage for holding a print head, which carriage is moveable along a carriage scan-axis for applying an ink image to a strip of receiving material,
transporting means for stepwise advancing the receiving material in a direction of advance, which extends to a direction substantially orthogonal to the carriage scan-axis, and
a camera mounted on the carriage adjacent to the print head for detecting a reference pattern, wherein the camera is arranged for imaging an area which extends in the direction of advance.

In one embodiment, the printer further includes:
calculation means for determining variations in said stepwise advancing of the receiving material from the detected reference pattern, and
correction means for adjusting the position of the receiving material in the direction of advance for at least partially correcting for said variations.

In an embodiment of the printer according to the present invention the camera includes a CCD camera.

In another embodiment, the camera includes a line-scan camera. Such a line scan camera may consists of one (for a monochrome camera) or three rows of pixels (each for detecting a different color). An advantage of such a camera is that the read-out is relatively quick when compared with the read-out time for a camera, which generally contains a number of rows which is of the same magnitude as the number of pixels in a row (Area CCD).

In one embodiment, the row of pixels of the line-scan camera is orientated such that it extends substantially orthogonal to the carriage scan-axis. Due to the movement of the carriage, the line-scan camera is moved over a strip of receiving material. By repeatedly reading out the line-scan camera during the movement of the carriage over the print area, this print area can, in principle, be completely recorded.

In another embodiment, the camera is arranged for imaging an area which extends in the direction of advance over a distance which is larger than a step of the stepwise advancing of the receiving material.

In one embodiment of the printer according to the present invention, the printer further includes processing means for introducing the reference pattern in the ink image.

In the embodiment, the printer is adapted for printing the ink image in two or more passes of the carriage over the strip of receiving material.

In another embodiment, the printer includes a print head containing a first printing device for printing an ink image of a first color and a second printing device for printing an ink image of a second color, wherein the second color is different from the first color, which first and second printing devices are mounted adjacent to each other, wherein the first printing device is displaced in the direction of advance with respect to the second printing device.

In a further embodiment, the first printing device utilizes yellow ink and is the first of the printing devices to print on a strip of receiving material.

In the embodiment, the printer includes processing means for processing ink image data for introducing the reference pattern in a first part of ink image for printing said reference pattern during the first pass, and for introducing a compensation pattern in a second part of the ink image for printing said compensation pattern during the second or a subsequent pass, wherein said compensation pattern neutralizes said reference pattern.

In one embodiment, the reference pattern includes a high frequency component parallel to a carriage scan-axis.

In another embodiment, the printer comprises a first line-scan camera and a second line-scan camera which are placed at both sides of the print head. When a line scan camera is mounted on both sides of the print head, then every local paper step can be corrected.

From another aspect, the present invention pertains to a method for applying an ink image to a receiving material using a printer, said method including the steps of:
moving a carriage comprising a camera and a print head for printing a swath of the ink image in a direction wherein the camera is positioned upstream to the print head,
detecting the position of a reference pattern on the receiving material relative to the carriage using the camera, determining deviations in said position from a desired position, and adjusting the position of the receiving material for at least partially correcting for said deviations, during the movement of the carriage.

### BRIEF DESCRIPTION OF THE DRAWINGS

The invention will be further described in connection with the attached drawings wherein:

FIG. 1 shows a schematic drawing of an embodiment of the printer according to the present invention;

FIGS. 2A, 2B, 2C and 2D show various steps in the methods of the present invention;

FIG. 3 shows the increase in the amount of ink in a multipass printer using four passes for printing the total amount of needed ink; and

FIG. 4 schematically shows the amount of ink, wherein a high frequency component is added as a reference pattern.

### DETAILED DESCRIPTION OF THE INVENTION

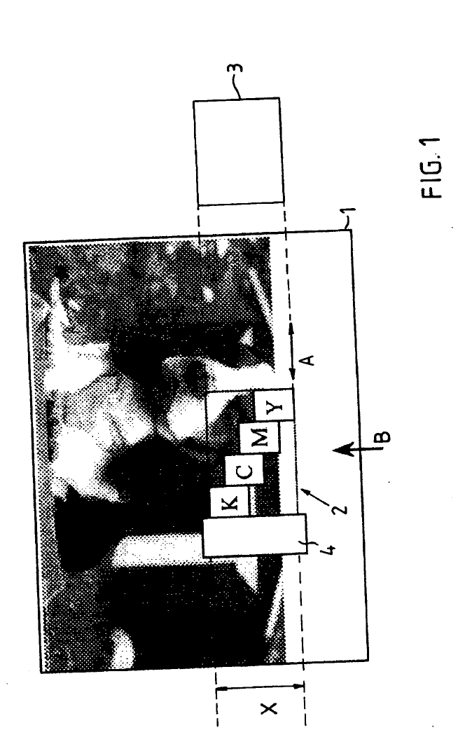

A simplified printer situation is presented in FIG. 1. FIG. 1 shows a top view of a receiving material 1 (in this case paper) onto which an ink image is printed. For printing the ink image, the printer utilizes a carriage 2 which is movable along a carriage scan-axis A for applying the ink image to the paper 1. The paper 1 is stepwise advanced in the direction of advance B, which extends in the direction substantially orthogonal to the carriage scan-axis A. During the printing of an image the carriage 2 is driven back and forth along the scan-axis A to print the successive swaths with the print head. When not in use the print head is stored in a capping station 3 which is situated at one end of the scan path of the carriage 2. The carriage 2 is provided with a print head comprising four printing devices Y, M, C and K which are displaced with respect to each other in the direction of advance B. The first printing device that prints on a strip of paper is the printing device Y for printing yellow ink. The subsequent second, third and fourth printing devices are magenta, cyan and black ink respectively. The printing devices Y, M, C and K are distributed over the height of the print area X. Adjacent to the print head a camera 4 is mounted on the carriage 2, for imaging an area which extends in the direction of advance B. Preferably the area detectable by the camera 4 extends in the direction of advance B over a distance which is larger than the height of the print area X.

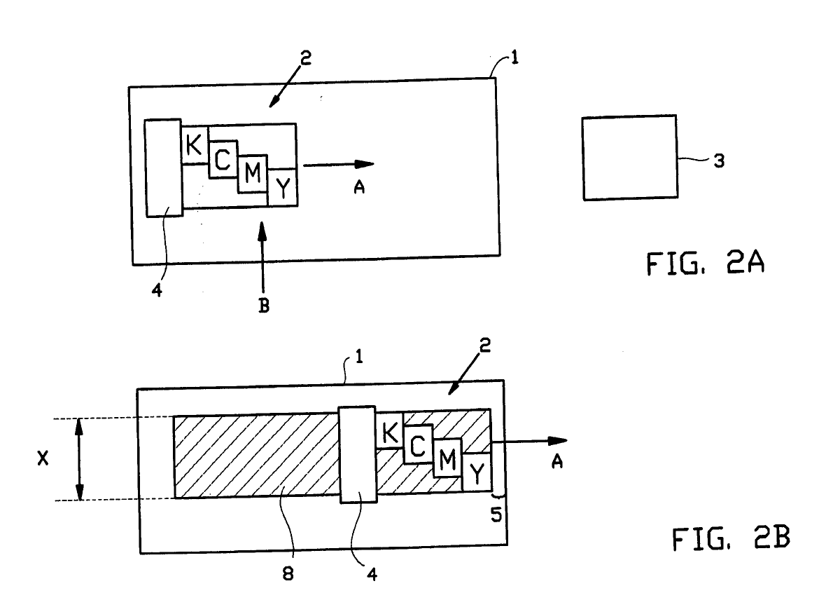

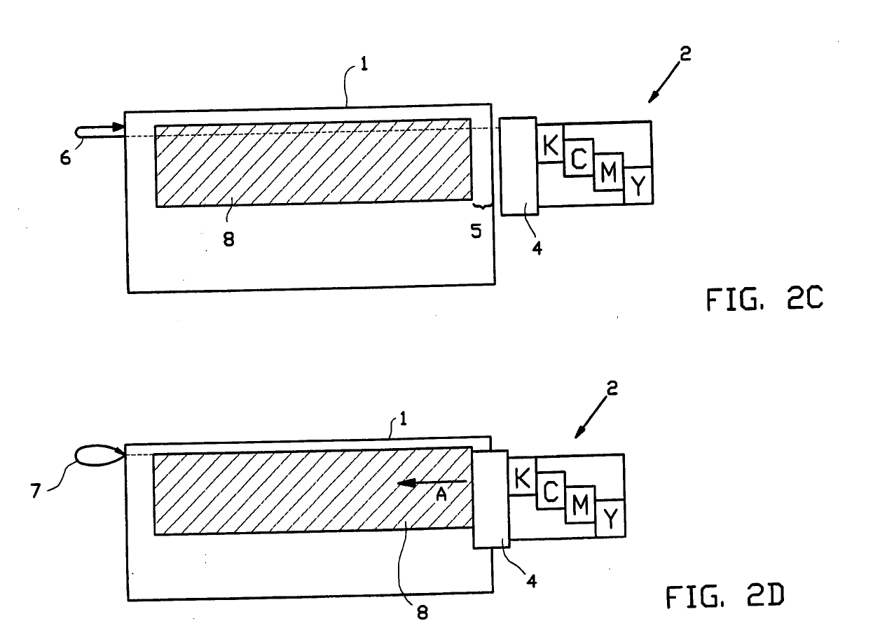

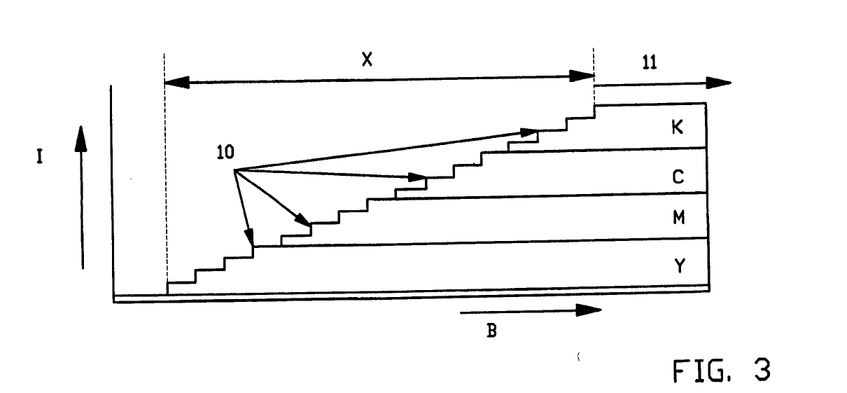

The FIGS. 2A, 2B, 2C and 2D schematically show an embodiment of the method according to the present invention. In the initial situation, as shown in FIG. 2A, the carriage 2 is moving in a direction such that the camera 4 is positioned downstream to the printing devices Y, M, C and K. A part of the ink image is printed on the paper 1 and is scanned by the camera 4 just after the printing. In this step of the process, not only the ink image is printed, but also a reference pattern. Such a reference pattern can, for example, be printed in a safety margin 5 along the edge of the paper 1, as shown in FIG. 2B. After printing this preference pattern by the printing devices, for example the printing device Y containing yellow ink, this reference pattern is scanned by the camera 4.

Subsequently the carriage 2 changes direction and the paper 1 is moved one swath forward as indicated by the arrow 6 in FIG. 2C. Now the movement of the carriage 2 is such that the camera 4 is mounted upstream with respect to the printing devices Y, M, C and K. In this situation the camera 4 can detect the position of the reference pattern which was printed in the previous swath. The camera 4 scans the reference pattern, which was printed for example within the safety margin 5, before the printing devices print the first dots of this swath. If the detected position of the reference pattern deviates from the desired position, this deviation is determined and the position of the paper 1 is adjusted to correct for said deviation. The arrow 7 in FIG. 2D represents this adjustment. Such an adjustment (for instance in the order of 10 micrometer) is initiated before the printing devices Y, M, C and K will print the first dots in this swath, that is, before the printing device K containing black ink reaches the image area 8. In this way, every local paper step made when the carriage 2 is moved in the direction wherein the camera 4 is in an upstream position with respect to the printing devices Y, M, C and K, can be corrected. Paper steps made at the other side of the paper 1 (if any) can only be corrected with the next paper step. As a result, the average paper step (the average of more than one paper step) will be more accurate. However when a camera 4 is placed at both sides of the carriage 2, then every local paper step could be corrected.

FIG. 2 shows that the ink image is printed in two or more passes of the carriage 2 over the paper 1, wherein the paper 1 advances stepwise in the direction of advance B after each pass. In order to be able to print an ink image using such a multipass printer, the ink image data must be processed for splitting up the image to be printable in multiple passes. This processing is performed using a so-called multipass mask. In such a multipass printer, the total amount of needed ink on a certain position in the ink image is printed in two or more passes. For example, the total amount of needed ink is printed in four passes as schematically shown in FIG. 3. FIG. 3 shows the average ink amount I as a function of the position along the direction of advance B. Naturally the amount of ink varies for every position along the scan access A, but FIG. 3 is simplified for clarity. As a consequence of this, the amount of ink increases in four steps in the direction of advance of the paper B. All the places where the amount of ink increases, referred to as multipass edges 10, can be used to measure the paper steps of the previous (1, 2 or 3) paper steps. For clarity reasons, only a few example multipass edges are indicated with the reference number 10 in FIG. 3. These multipass edges 10 are visible in the print area (here represented by the height of print area X). More than the three previous paper steps cannot be measured this way, because after four passes the desired amount of ink is placed, and the printing is completed (as denoted by reference number 11 in FIG. 3).

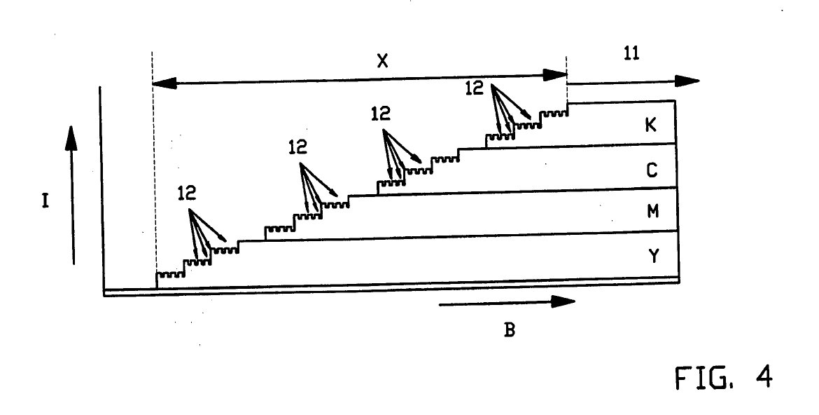

The above described method using of the multipass edges of the multipass printing process can be enhanced by introducing a high frequency component in the multipass mask. Again, in the example as shown in FIG. 4, the total amount of needed ink is printed in four passes, but now the multipass mask is adapted in such a way that a high frequency component 12 is visible in the direction of advance B. For clarity reasons, only a few example modulations due to the high frequency component 12 are indicated with the reference number 12 in FIG. 4. This high frequency component 12 may be visible as white or grey lines which are dispersed over the width of the paper 1. The last pass of the four passes corrects the high frequency component so that it will not be visible in the final print 11. It will be visible though for the camera 4 in the three previous passes. In this way not only the multipass edges 10 can be used to measure the paper step, but also all the positions of the high frequency component 12, making the measurement better because more measurements can be made and more nozzles of the printing devices Y, M, C and K will be used. This also eliminates a possible poor nozzle just on a multipass edge, which normally could have disturbed the measurement.

Because the camera 4 is moved over the printing area 8, a line-scan camera can be applied. Such a line-scan camera may consists of three rows of for example 2700 pixels (each row for detecting a different color). Preferably, the height of the print area X is imaged over the complete length of the array formed by the rows of 2700 pixels, yielding a high resolution. The array of the line-scan camera 4 is orientated such that it extends substantially orthogonal to the carriage scan-axis A. Due to the movement of the carriage 2, the line-scan camera 4 is moved over a strip of receiving material 1. By repeatedly reading out the line-scan camera 4 during the movement of the carriage 2 over the print area 8, this print area 8 can in principle completely be recorded.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for applying an ink image to a receiving material using a printer including:
a carriage for holding a print head, said carriage being moveable along a carriage scan-axis for applying an ink image to a strip of receiving material,
transporting means for the stepwise advancing of the receiving material in a direction of advance, which extends in a direction substantially orthogonal to the carriage scan-axis, and
a camera mounted on the carriage adjacent to the print head for detecting a reference pattern, wherein the camera is arranged for imaging an area which extends in the direction of advance,
said method comprising the steps of:
moving the carriage for printing a swath in a direction wherein the camera is positioned upstream of the print head,
detecting the position of a reference pattern on the receiving material relative to the carriage,
determining deviations in said position from a desired position, and
adjusting the position of the receiving material in the direction of advance for at least partially correcting for said deviations, during the movement of the carriage.

2. The method according to claim 1, wherein the method further comprises the step of printing the reference pattern using the print head.

3. The method according to claim 2, wherein the reference pattern is printed during the movement of the carriage wherein the camera is mounted downstream with respect to the print head.

4. The method according to claim 3, wherein the reference pattern is printed and detected in one swath.

5. The method according to claim 2, wherein the camera images an area which extends in the direction of advance over a distance which is larger than a step of the stepwise advancing of the receiving material.

6. The method according to claim 2, wherein the reference pattern is printed within a safety margin along the edge of the receiving material.

7. The method according to claim 2, wherein the printer comprises processing means, and wherein the method comprises the step of processing ink image data by said processing means for introducing the reference pattern into the ink image.

8. The method according to claim 6, wherein the printed reference pattern is invisible to the naked eye.

9. The method according to claim 6, wherein the reference pattern is printed using yellow ink.

10. The method according to claim 6, wherein the printed reference pattern comprises a line or dot pattern which extends substantially perpendicular to the direction of advance.

11. The method according to claim 2, wherein the ink image is printed in two or more passes of the carriage over the strip of receiving material, wherein the receiving material is stepwise advanced in the direction of advance, after each pass.

12. The method according to claim 11, wherein the print head comprises a first printing device for printing a first color of the ink image and a second printing device for printing a second color of the ink image, wherein the second color is different from the first color, which first and second printing devices are mounted adjacent to each other, wherein the first printing device is displaced in the direction of advance with respect to the second printing device, and wherein the method further comprises the steps of:
moving the carriage over the strip of receiving material for a first pass, wherein only the first printing device prints on at least a part of the strip of receiving material,
advancing the receiving material in the direction of advance over at least one step, and
moving the carriage over the strip of receiving material for a second pass, wherein the second printing device prints on said part of the strip of receiving material.

13. The method according to claim 11, wherein the printer includes processing means, and wherein the method comprises the step of processing ink image data by said processing means for introducing the reference pattern in a first part of ink image and printing said reference pattern during the first pass, and introducing a compensation pattern in a second part of the ink image and printing said compensation pattern during the second or a subsequent pass, wherein said compensation pattern neutralizes said reference pattern.

14. The method according to claim 13, wherein the reference pattern is printed using yellow ink.

15. The method according to claim 13, wherein the reference pattern comprises a high frequency component substantially parallel to the carriage scan-axis.

16. A printer for applying an ink image to a receiving material, comprising:
a carriage for holding a print head, said carriage being moveable along a carriage scan-axis for applying an ink image to a strip of receiving material,
transporting means for the stepwise advancing of the receiving material in a direction of advance, which extends to a direction substantially orthogonal to the carriage scan-axis,
a camera mounted on the carriage adjacent to the print head for detecting a reference pattern, wherein the camera is arranged for imaging an area which extends in the direction of advance.

17. The printer according to claim 16, wherein the printer further comprises:
calculation means for determining variations in said stepwise advancing of the receiving material from the detected reference pattern, and
correction means for adjusting the position of the receiving material in the direction of advance for at least partially correcting for said variations.

18. The printer according to claim 16, wherein the camera comprises a CCD camera.

19. The printer according to claim 16, wherein the camera comprises a line-scan camera.

20. The printer according to claim 16, wherein the camera is arranged for imaging an area which extends in the direction of advance over a distance which is larger than a step of the stepwise advancing of the receiving material.

21. The printer according to claim 16, wherein the printer further comprises processing means for introducing the reference pattern in the ink image.

22. The printer according to claim 16, wherein the printer is adapted for printing the ink image in two or more passes of the carriage over the strip of receiving material.

23. The printer according to claim 22, wherein the printer comprises a print head containing a first printing device for printing an ink image of a first color and a second printing device for printing an ink image of a second color, wherein the second color is different from the first color, which first and second printing devices are mounted adjacent to each other, wherein the first printing device is displaced in the direction of advance with respect to the second printing device.

24. The printer according to claim 23, wherein the first printing device comprises yellow ink and is the first of the printing devices to print on a strip of receiving material.

25. The printer according to claim 22, wherein the printer comprises processing means for processing ink image data for introducing the reference pattern in a first part of ink image for printing said reference pattern during the first pass, and for introducing a compensation pattern in a second part of the ink image for printing said compensation pattern during the second or a subsequent pass, wherein said compensation pattern neutralizes said reference pattern.

26. The printer according to claim 25, wherein the reference pattern comprises a high frequency component parallel to the carriage scan-axis.

27. The printer according to claim 16, wherein the printer comprises a fist camera and a second camera, which are placed at both sides adjacent to the print head.

28. A method for applying an ink image to a receiving material using a printer, said method comprises the steps of:
moving a carriage comprising a camera and a print head for printing a swath of the ink image in a direction wherein the camera is positioned upstream to the print head,
detecting the position of a reference pattern on the receiving material relative to the carriage using the camera,
determining deviations in said position from a desired position, and
adjusting the position of the receiving material for at least partially correcting for said deviations, during the movement of the carriage.
